(19) United States
(12) Patent Application Publication
(10) Pub. No.: US 2021/0299823 A1
(43) Pub. Date: Sep. 30, 2021

(54) Ratcheting Pliers Device

(71) Applicant: Brian Thomas, Bridgeport, OH (US)

(72) Inventor: Brian Thomas, Bridgeport, OH (US)

(21) Appl. No.: 16/827,894

(22) Filed: Mar. 24, 2020

(51) Int. Cl. B25B 7/02; B25B 7/14; B25B 7/18

(52) U.S. Cl. CPC B25B 7/02; B25B 7/18; B25B 7/14

(57) ABSTRACT

A ratcheting pliers device for extracting a fastener from a substrate includes a first arm, which is pivotally engaged to a second arm to define a pair of jaws and a pair of handles. Each jaw has a cutout for insertion of a head of a fastener. A ratchet bar, which is pivotally engaged to the first arm, has a plurality of first teeth extending from its upper surface. A biaser engaged to the first arm and the ratchet bar is positioned to pivot the ratchet bar into engagement with a second tooth that is coupled to the second arm. The second tooth sequentially engages the first teeth as the first arm and the second arm are motivated to a proximate orientation, concurrently with the jaws being motivated to a closed configuration. The jaws are prevented from opening while a user pulls on the handles to extract the fastener.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pliers devices and more particularly pertains to a new pliers device for extracting a fastener from a substrate.

### (2) Description of Related Art including Information disclosed under 37 CFR 1.97 and 1.98.

The prior art relates to pliers devices. Prior art ratcheting pliers devices may comprise pliers with a variety of ratcheting mechanisms and having jaws that are configured for a variety of tasks, such as gripping, crimping, and cutting. The prior are does not teach a ratcheting pliers having a pair of jaws that is configured for pulling a fastener from a substrate.

### BRIEF SUMMARY OF THE INVENTION

An embodiment of the disclosure meets the needs presented above by generally comprising a first arm, which is pivotally engaged to a second arm to define a pair of jaws and a pair of handles. Each jaw has a cutout extends thereinto, which is configured for insertion of a head of a fastener as the jaws are motivated to a closed configuration.

A ratchet bar is pivotally engaged to the first arm, proximate to a first terminus thereof. The ratchet bar has a plurality of first teeth extending from an upper surface thereof. A biaser is engaged to the first arm and the ratchet bar and is positioned to pivot the ratchet bar into engagement with a lower limit of the second arm.

A second tooth is coupled to and extends from the second arm. The second tooth is positioned to sequentially engage the first teeth of the ratchet bar as the first arm and the second arm are motivated to a proximate orientation, concurrently with the jaws being motivated to the closed configuration. The jaws thus are prevented from opening. The user is positioned to pull on the handles to extract the fastener from a substrate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a ratcheting pliers device according to an embodiment of the disclosure.

FIG. 2 is a side view of an embodiment of the disclosure.

FIG. 3 is a rear view of an embodiment of the disclosure.

FIG. 4 is an in-use view of an embodiment of the disclosure.

### DETAILED DESCRIPTION OF THE INVENTION

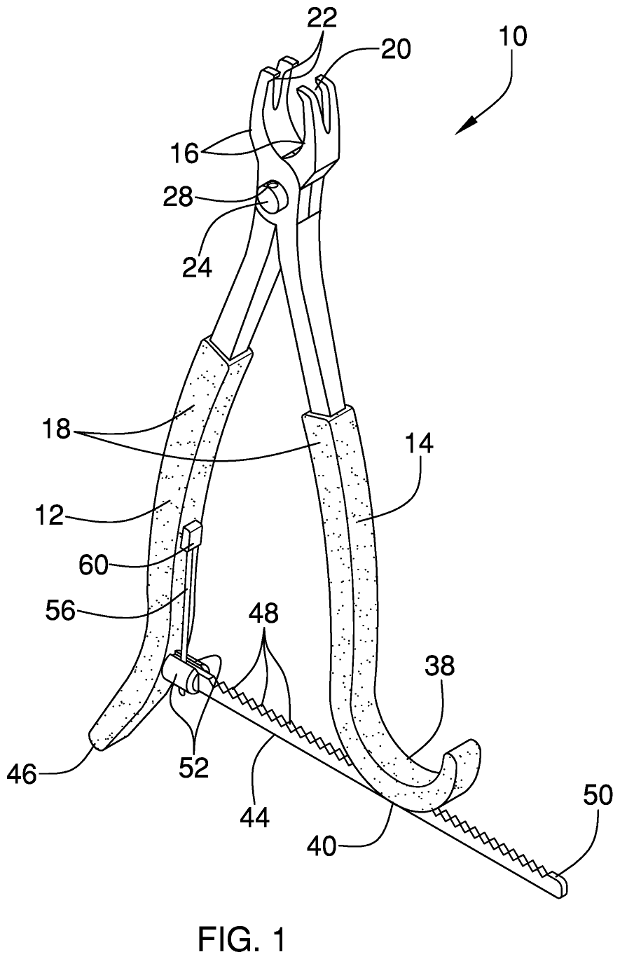

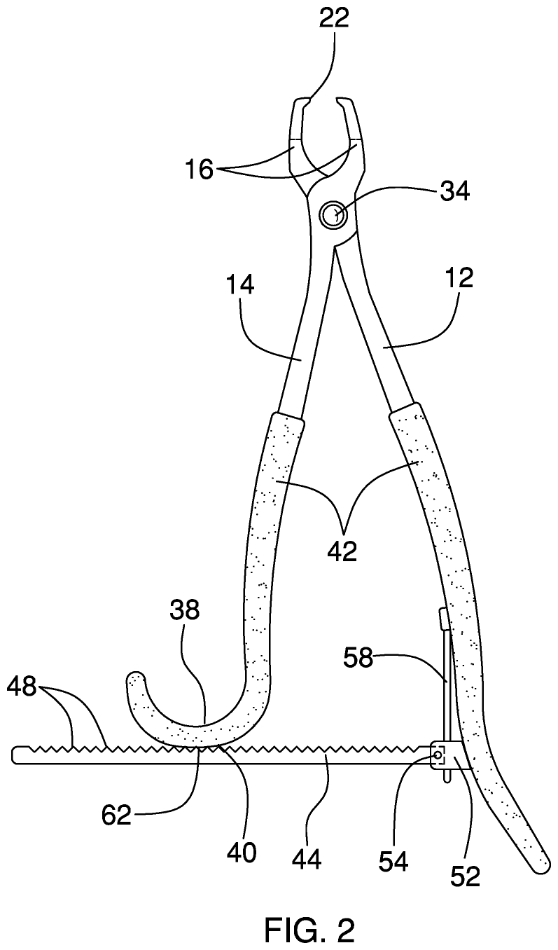

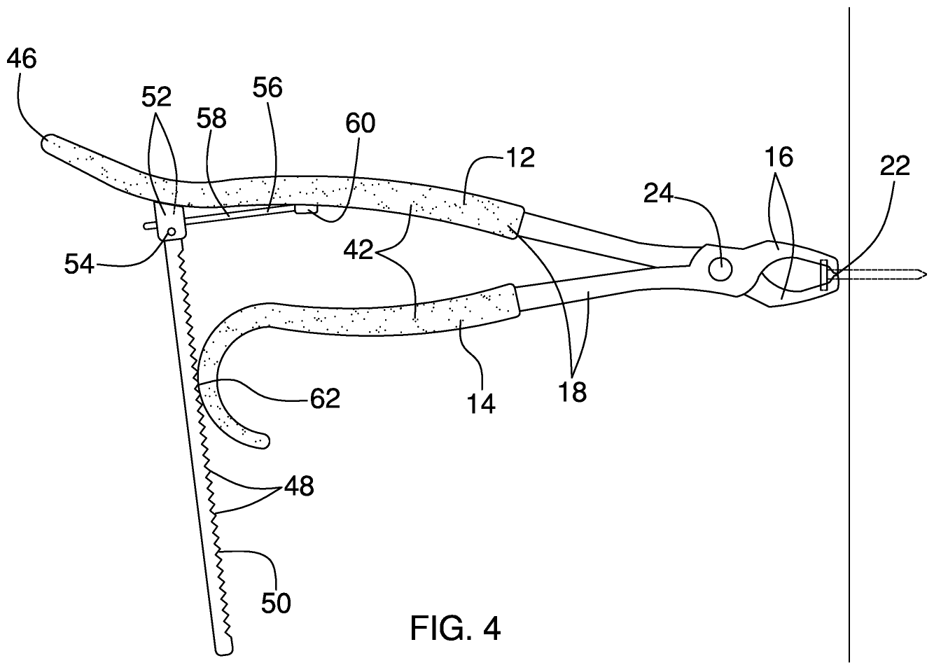

With reference now to the drawings, and in particular to FIGS. 1 through 4 thereof, a new pliers device embodying the principles and concepts of an embodiment of the disclosure and generally designated by the reference numeral 10 will be described.

As best illustrated in FIGS. 1 through 4, the ratcheting pliers device 10 generally comprises a first arm 12, which is pivotally engaged to a second arm 14 to define a pair of jaws 16 and a pair of handles 18. Each jaw 16 has a cutout 20 extending thereinto, which is configured for insertion of a head of a fastener, such as a nail, screw, bolt, staple, and the like, as the jaws 16 are motivated to a closed configuration. Each jaw 16 is substantially L-shaped so that each cutout 20 defines a pair of claws 22.

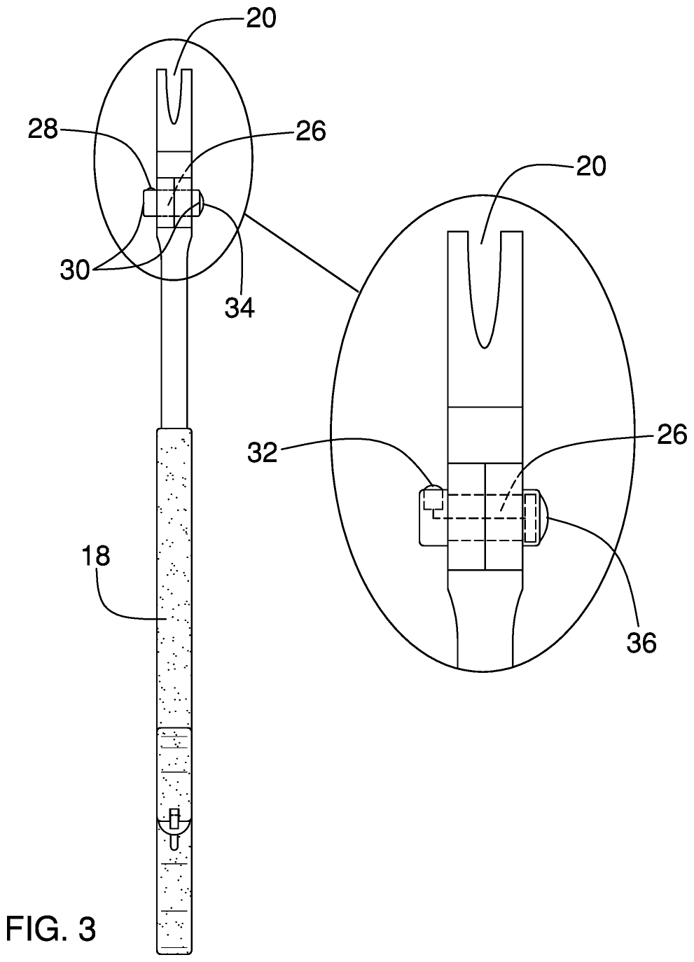

A pivot 24 is engaged to and extends through the first arm 12 and the second arm 14 so that the first arm 12 is pivotally engaged to the second arm 14. The pivot 24 is tubular and has a battery 26 positioned therein. A bulb 28 is engaged to the pivot 24 proximate to one opposed end 30 thereof. The bulb 28 may comprise a light emitting diode 32, as shown in FIG. 3. A switch 34 is engaged to the other of the opposed ends 30 of the pivot 24. The switch 34 is operationally engaged to the bulb 28 and the battery 26, and thus is positioned to selectively couple the bulb 28 to the battery 26 to power the bulb 28. The bulb 28 is configured to illuminate an area proximate to the jaws 16 to facilitate use of the device 10 in low light conditions. The switch 34 may comprise a button 36, which is depressible, or other switching means, such as, but not limited to, toggle switches, slid switches, and the like.

The second arm 14 has a bend 38 positioned therein proximate to a lower limit 40 thereof. The bend 38 is substantially C-shaped and is configured to deter slippage of a hand positioned upon the second arm 14. Each handle 18 has a grip 42 engaged thereto. The grips 42 are configured to enhance a grasp of a hand of a user upon the pair of handles 18.

A ratchet bar 44 is pivotally engaged to the first arm 12, proximate to a first terminus 46 thereof. The ratchet bar 44 has a plurality of first teeth 48 extending from an upper surface 50 thereof. A pair of brackets 52 is coupled to the first arm 12. The ratchet bar 44 is pivotally engaged to a rod 54, which is coupled to and which extends between the brackets 52.

A biaser 56 is engaged to the first arm 12 and the ratchet bar 44 and is positioned to pivot the ratchet bar 44 into engagement with a lower limit 40 of the second arm 14. The biaser 56 comprises a plate spring 58, which has a first endpoint 60 coupled to the first arm 12 between the pair of brackets 52 and the pair of jaws 16. The plate spring 58 extends between the pair of brackets 52, toward the first terminus 46 of the first arm 12. The plate spring 58 is positioned to bias the ratchet bar 44 into engagement with the lower limit 40 of the second arm 14.

A second tooth 62 is coupled to and extends from the second arm 14. The second tooth 62 is positioned to sequentially engage the first teeth 48 of the ratchet bar 44 as the first arm 12 and the second arm 14 are motivated to a proximate orientation, concurrently with the jaws 16 being motivated to the closed configuration. The jaws 16 thus are prevented from opening. The user is positioned to pull on the handles 18 to extract the fastener from a substrate.

In use, the user positions the jaws 16 proximate to the head of the fastener that is to be extracted, so that the cutouts 20 are aligned with the head. As the user motivates the jaws 16 to the closed configuration, the claws 22 are inserted beneath the head of the fastener. Concurrently, the second tooth 62 sequentially engages the first teeth 48 so that the jaws 16 are prevented from opening. The user thus is positioned to pull on the handles 18 to extract the fastener from a substrate.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A ratcheting pliers device comprising:
a first arm and a second arm, the first arm and the second arm being pivotally engaged defining a pair of jaws and a pair of handles, each jaw having a cutout extending thereinto, wherein the cutout is configured for insertion of a head of a fastener as the jaws are motivated to a closed configuration;
a ratchet bar pivotally engaged to the first arm proximate to a first terminus thereof, the ratchet bar having a plurality of first teeth extending from an upper surface thereof;
a biaser engaged to the first arm and the ratchet bar, such that the biaser is positioned for pivoting the ratchet bar into engagement with a lower limit of the second arm; and
a second tooth coupled to and extending from the second arm, such that the second tooth is positioned for sequentially engaging the first teeth of the ratchet bar as the first arm and the second arm are motivated to a proximate orientation, concurrent with the jaws being motivated to the closed configuration, such that the jaws are prevented from opening, positioning the user for pulling on the handles, for extracting the fastener from a substrate.

2. The ratcheting pliers device of claim 1, wherein the second arm has a bend positioned therein proximate to the lower limit, the bend being substantially C-shaped, wherein the bend is configured for deterring slippage of a hand positioned upon the second arm.

3. The ratcheting pliers device of claim 1, wherein each jaw is substantially L-shaped such that each cutout defines a pair of claws.

4. The ratcheting pliers device of claim 1, further including:
a pivot engaged to and extending through the first arm and the second arm such that the first arm is pivotally engaged to the second arm, the pivot being tubular;
a bulb engaged to the pivot proximate to one opposed end thereof;
a battery positioned in the pivot; and
a switch engaged to the other of the opposed ends of the pivot, the switch being operationally engaged to the bulb and the battery, such that the switch is positioned for selectively coupling the bulb to the battery for powering the bulb, wherein the bulb is configured for illuminating an area proximate to the jaws.

5. The ratcheting pliers device of claim 4, wherein the bulb comprises a light emitting diode.

6. The ratcheting pliers device of claim 4, wherein the switch comprises a button, the button being depressible.

7. The ratcheting pliers device of claim 1, further including each handle having a grip engaged thereto, wherein the grips are configured for enhancing a grasp of a hand of a user upon the pair of handles.

8. The ratcheting pliers device of claim 1, further including:
a pair of brackets coupled to the first arm;
a rod coupled to and extending between the brackets, the ratchet bar being pivotally engaged to the rod; and
the biaser comprising a plate spring, the plate spring having a first endpoint coupled to the first arm between the pair of brackets and the pair of jaws, the plate spring extending between the pair of brackets toward the first terminus of the first arm, such that the plate spring is positioned for biasing the ratchet bar into engagement with the lower limit of the second arm.

9. A ratcheting pliers device comprising:
a first arm and a second arm, the first arm and the second arm being pivotally engaged defining a pair of jaws and a pair of handles, each jaw having a cutout extending thereinto, wherein the cutout is configured for insertion of a head of a fastener as the jaws are motivated to a closed configuration, the second arm having a bend positioned therein proximate to a lower limit thereof, the bend being substantially C-shaped, wherein the bend is configured for deterring slippage of a hand positioned upon the second arm, each jaw being substantially L-shaped such that each cutout defines a pair of claws;
a pivot engaged to and extending through the first arm and the second arm such that the first arm is pivotally engaged to the second arm, the pivot being tubular;
a bulb engaged to the pivot proximate to one opposed end thereof, the bulb comprising a light emitting diode;
a battery positioned in the pivot;
a switch engaged to the other of the opposed ends of the pivot, the switch being operationally engaged to the bulb and the battery, such that the switch is positioned for selectively coupling the bulb to the battery for powering the bulb, wherein the bulb is configured for illuminating an area proximate to the jaws, the switch comprising a button, the button being depressible;
each handle having a grip engaged thereto, wherein the grips are configured for enhancing a grasp of a hand of a user upon the pair of handles;
a ratchet bar pivotally engaged to the first arm proximate to a first terminus thereof, the ratchet bar having a plurality of first teeth extending from an upper surface thereof;
a pair of brackets coupled to the first arm;
a rod coupled to and extending between the brackets, the ratchet bar being pivotally engaged to the rod;
a biaser engaged to the first arm and the ratchet bar, such that the biaser is positioned for pivoting the ratchet bar into engagement with the lower limit of the second arm, the biaser comprising a plate spring, the plate spring having a first endpoint coupled to the first arm between the pair of brackets and the pair of jaws, the plate spring extending between the pair of brackets toward the first terminus of the first arm, such that the plate spring is positioned for biasing the ratchet bar into engagement with the lower limit of the second arm; and
a second tooth coupled to and extending from the second arm, such that the second tooth is positioned for sequentially engaging the first teeth of the ratchet bar as the first arm and the second arm are motivated to a proximate orientation, concurrent with the jaws being motivated to the closed configuration, such that the jaws are prevented from opening, positioning the user for pulling on the handles, for extracting the fastener from a substrate.
